(19) United States
(12) Patent Application Publication
(10) Pub. No.: US 2026/0145794 A1
(43) Pub. Date: May 28, 2026

(54) AIRCRAFT BLEED AIR SYSTEM AND METHOD FOR MONITORING

(71) Applicant: AIRBUS OPERATIONS S.L., Madrid (ES)

(72) Inventors: Juan-Luis CARRION-BENEDITO, Madrid (ES); Angel GARCIA ZUAZO, Madrid (ES); Alejandro SAEZ MOLLEJO, Madrid (ES)

(21) Appl. No.: 19/400,818

(22) Filed: Nov. 25, 2025

(30) Foreign Application Priority Data
Nov. 25, 2024 (EP) 24383273-0

(51) Int. Cl. B64D 13/02; B64D 45/00; F02C 9/18

(52) U.S. Cl. CPC B64D 13/02; F02C 9/18; B64D 2045/0085

(57) ABSTRACT

An aircraft bleed air system including an engine (13) having a first pressure port (3) and a second pressure port (4); a pressure valve (11) placed downstream of the second pressure port (4); and a pressure regulating valve (2) placed downstream of the first pressure port (3) and the pressure valve (11). A method detects a bleed pressure evolution in a transient from a moment when a pressure regulating valve (2) is fully open and a moment in which a pressure valve (11) is opened; determining that the pressure regulating valve (2) functions correctly if the detected pressure transient is higher than a preset value; or determining that the pressure regulating valve (2) is damaged if the detected pressure transient is lower than a preset value, identifying an event.

### RELATED APPLICATION

This application incorporates by reference and claims priority to European patent application 24383273-0, filed Nov. 25, 2024.

### TECHNICAL FIELD

The present invention relates to an aircraft bleed air system and method for its monitoring, in particular, for determining a predictive maintenance for aircrafts, and aimed for the identification of pressure regulation issues in aircraft valves, such as aircraft electro-pneumatic valves.

### BACKGROUND

In aircraft, it is necessary to monitor their components, one of them being the valves, such as electro-pneumatic valves for identifying pressure regulation issues.

An aircraft comprises a bleed monitoring computer (BMC} which monitors and controls a bleed air system in an aircraft. The bleed air system provides compressed air to various components on an aircraft, such as an engine starter, cabin pressurization system and air-conditioning system. The compressed air may be obtained by bleeding compressed air from a compressor in an engine of the aircraft or from a source of compressed air external to the aircraft.

The BMC continuously monitors the status and functionality of the bleed air system, ensuring that it operates within safe limits and protecting against potential failures.

The system monitoring performed by current BMCs is focused on safe system operation and issuing alerts identifying potentially unsafe conditions. Troubleshooting related to the alerts requires time, qualified personal and sometimes special means. This can lead to operational interruptions impacting operators' cost and image.

There is a need for BMCs that predict maintenance before failures and unsafe conditions occur in a bleed system. Issuing alerts about predictions of maintenance would allow maintenance on bleed systems to be performed before failures occur. This would improve the operational reliability of the bleed system and the overall aircraft. A BMC that provided alerts regarding predicted maintenance would allow for scheduling of aircraft maintenance and arranging for spare parts to be at locations where the maintenance is to be performed.

One solution for pneumatic valves predictive maintenance is based on opening/closing time monitoring. However, this solution is not suitable for many modern bleed air systems that do not include mechanical switches for position measurement.

### SUMMARY

The invention may be embodied as an aircraft bleed air system and a method for its monitoring that permits a predictive maintenance of the valves of the bleed air system, in particular, electro-pneumatic valves of an aircraft, so that the bleed air system of an aircraft can be monitored.

The system and method of the invention solve the above-mentioned disadvantages and has other advantages which will be described below.

In particular, the aircraft bleed air system comprises: an engine with a compressor having a first pressure port supplying pressure at a low or intermediate pressure, and a second port supplying compressed air at a high pressure than provided by the first port; a pressure valve downstream of the second pressure port; and a pressure regulating valve placed downstream of the first pressure port and the pressure valve.

Furthermore, the pressure regulating valve may be connected to a pressure regulator that regulates a pressure difference between an opening chamber and a closing chamber, wherein the opening and closing chambers are between the pressure regulating valve and the pressure regulator.

According to an embodiment, the pressure regulator valve is connected to the closing chamber by a sense line.

The regulator may be fed by a motor that is connected to a controller.

Furthermore, a pressure check valve may be placed between the intermediate pressure port and the pressure regulating valve.

The aircraft bleed air system may include a bleed manifold pressure sensor upstream of the pressure regulating valve and a bleed pressure sensor placed downstream of the pressure regulating valve.

A method for monitoring the aircraft bleed air system comprises the following steps: detecting a bleed pressure evolution in a transient from a moment when a pressure regulating valve is fully open and a moment in which a pressure valve is opened; determining that the pressure regulating valve functions correctly if the detected pressure transient is higher than a preset value; or determining that the pressure regulating valve is damaged if the detected pressure transient is lower than a preset value, identifying an event.

An alert is emitted if a plurality of events is identified in a predetermined time lapse.

For identifying an event the following aircraft parameters can also be monitored during a flight in both sides of the aircraft:
Altitude (ALT);
Flight Phase (FP);
Pressure Regulating Valve closure command (LH_PRV_CMD and RH_PRV_CMD);
Pressure Valve closure command (LH_HPV_CMD and RH_HPV_CMD)
Pressure upstream the pressure valve by a Bleed Manifold Pressure Sensor (LH_BMPS and RH_BMPS); and
Pressure downstream the pressure valve by a Bleed Pressure Sensor (LH_BMPS and RH_BMPS).

Furthermore, according to an embodiment, for each flight, each side XX, wherein XX can be right (RH) or left, (LH) sides, identify time windows matching the following conditions:

```
  (FP = 6) AND (ALT > ALT_min_threshold);
  LH_PRV_CMD = 0 (open) and RH_PRV_CMD = 0 (open) with
N_seconds;
  XX_BMPS > BMPS_min_threshold,
  XX_HPV_CMD = 0 (open) and XX_HPV_CMD = 1 (closed)
N_seconds ago; and
XX_BMPS < BMPS_max_threshold N_seconds ago;
for each side of the aircraft for each time window, calculate:
Duration = T_end − T_start
Mean_Press_Error = Mean(XX_BPS − BPS_ref)
for each side of the aircraft for each flight, Discard the feature if
Duration < 3 s, the remaining number of features after this filter being
N_Features.
Max_Press_Error = Max(Mean_Press_Error)
Min_Press_Error = Min(Mean_Press_Error)
applying the following equations:
Max_Press_Error_percentage = (Max_Press_Error − A) / B
Min_Press_Error_percentage = (Min_Press_Error − A) / B
Press_Error_percentage = (Max_Press_Error_percentage +
Min_Press_Error_percentage) / 2
  for each side, an event is identified if:
Press_Error_percentage < Min_pressure_error_threshold; or
Press_Error_percentage > Max_pressure_error_threshold.
```

The system and method according to the present invention are able to identify mechanical problems that can lead to a situation in which the valve is not able to open enough, i.e., a low pressure scenario, or to close enough, i.e., an overpressure scenario. This is achieved by monitoring the behavior during pressure transients.

While solutions based on opening/closing time monitoring are aimed at anticipating a lack of closure capability, the method and system according to the present invention is aimed at the detection of a degradation of the regulation function.

For electro-pneumatic valves, where a control loop using regulated pressure feedback exists, it can be difficult to notice such problems in advance if the feedback signal is not monitored. The present invention focuses on a transient interval where the valve exhibits its purely pneumatic open loop behavior during a transition from fully open to a regulating position.

The invention may be embodied as an aircraft bleed air system comprising:
an engine comprising a first pressure port connected fluidically to an intermediate pressure in a compressor of the engine, and a second port connected fluidically to a high pressure in the compressor;
a first conduit having a first inlet connected to the first pressure port and a first outlet and a first intermediate connection between the first inlet and the first outlet;
a second conduit having a second inlet connected to the second pressure port and a second outlet connected to the first intermediate connection;
a high pressure valve in the second conduit and downstream of the second pressure port; and
a pressure regulating valve having an inlet connected to the first outlet and downstream of the first pressure port and the pressure valve.

The pressure regulating valve may be connected to a pressure regulator configured to regulate a pressure difference between an opening chamber and a closing chamber, wherein the opening chamber and the closing chamber are fluidically between the pressure regulating valve and the pressure regulator.

The pressure regulator valve may be fluidically connected to the closing chamber by a sense line which is fluidically connected to the opening chamber.

The regulator may be adjusted by a motor controlled by a controller.

The pressure check valve may be in the first conduit between the first pressure port and the pressure regulating valve.

The aircraft bleed air system may further include a bleed manifold pressure sensor coupled to the first conduit upstream of the pressure regulating valve.

The aircraft bleed air system may include a bleed pressure sensor coupled to a third conduit connected to and downstream of the pressure regulating valve.

The invention may be embodied as a method for monitoring an aircraft bleed air system, wherein the aircraft bleed system includes a first pressure port and a second pressure port both fluidically connected to a compressor of an engine; a high pressure valve downstream of the second pressure port; and a pressure regulating valve downstream of the first pressure port and the high pressure valve, wherein the method includes:
detecting a bleed pressure evolution in a transient occurring while the pressure regulating valve is fully open and the high pressure valve is opened;
determining that the pressure regulating valve functions correctly if the detected pressure transient is higher than a preset value;
determining that the pressure regulating valve is damaged if the detected pressure transient is lower than a preset value, and
issuing an alert of a defect or of a need of maintenance in response to the determination that the pressure regulating valve is damaged.

The method may include replacing or maintaining the pressure regulating valve in response to the alert.

The alert may be emitted only if a plurality of determinations that the pressure regulating valve is damaged during a predetermined period.

The invention may be embodied as a method to monitor an aircraft bleed air system that include: a first conduit including an inlet connected to a low or intermediate pressure port fluidically coupled to a low or intermediate portion of a compressor of an aircraft and an outlet connected to a pressure regulating valve; a second conduit including an inlet connected to fluidically connected to a high pressure portion of the compressor and an outlet connected to an intermediate connection in the first conduit upstream of the pressure regulating valve, and a high pressure valve in the second conduit,

wherein the method includes:
maintaining the pressure regulating valve in a fully open position while the high pressure valve is closed and preventing high pressure air from the high pressure portion from entering the first conduit;
opening the high pressure valve and thereafter adjusting the pressure regulating valve to regulate a flow of compressed air flowing from both the low or intermediate portion and the high pressure portion of the compressor to the pressure regulating valve;
during a period in which the high pressure valve is opened and the pressure regulating valve is fully opened, monitoring evolution of pressures in the first conduit downstream of the intermediate connection and upstream of the pressure regulating valve;
analyzing the evolution of the pressures to determine a pressure transient during the period;
determining that the pressure regulating valve is operating properly if the pressure transient is higher than a preset value;
determining that the pressure regulating valve is damaged or in need of maintenance if the detected pressure transient is lower than the preset value, and
issuing an alert of a defect or of a need of maintenance in response to the determination that the pressure regulating valve is damaged or in need of maintenance.

The method may include replacing or maintaining the pressure regulating valve in response to the alert.

The alert may be emitted only if a plurality of determinations that the pressure regulating valve is damaged during a predetermined period.

### SUMMARY OF DRAWINGS

For a better understanding of what has been explained above, some drawings are included in which, schematically and only by way of a non-limiting example, a practical case of embodiment is represented.

FIG. 1 is a schematic view of the aircraft bleed air system according to the present invention;

FIG. 2 is a schematic view of the pressure regulating valve of the system according to the present invention;

FIG. 3 is a graphic showing the bleed pressure evolution in the transient from a pressure regulating valve fully open to regulation after pressure valve opening for a healthy pressure regulating valve;

FIG. 4 is a graphic showing the bleed pressure evolution in the transient from a pressure regulating valve fully open to regulation after pressure valve opening for a damaged pressure regulating valve; and

FIG. 5 is a graphic showing the pressure degradation and the number of pressure events along time according to one example of the method according to the present invention.

### DETAILED DESCRIPTION

Firstly, in the present description, the following acronyms are used:
BMC: Bleed Monitoring Computer
BPS: Bleed Pressure Sensor
BMPS: Bleed Manifold Pressure Sensor
EBAS: Engine Bleed Air System
PACK: Pressurization Air Conditioning Kit
PID: Proportional Integral Derivative
PRV: Pressure Regulating Valve
HPV: High Pressure Valve
S/L: Sense line
WAI: Wing Anti-Ice
IP: Intermediate Pressure
HP: High Pressure

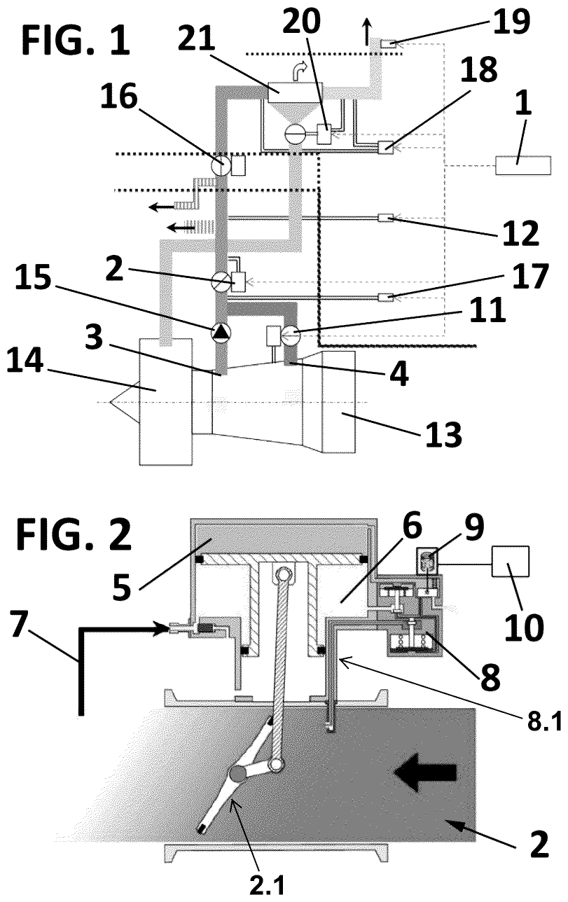

FIG. 1 schematically shows an example of the aircraft bleed air system, EBAS, according to the present invention, that is used to supply air from engines of an aircraft to consumers, mainly, PACKS and WAI.

One aircraft has two EBAS, one per engine. Each EBAS is designed to select the air source compressor stage for the associated engine at each moment, IP or HP regulate bleed air temperature and regulate bleed air pressure. Each EBAS is monitored and controlled by one BMC (1).

FIG. 1 shows an aircraft engine (13) with a fan (14), such as a turbofan engine. A pressure regulating valve (PRV) (2) of the EBAS is fluidically connected downstream of an intermediate pressure port (3) and a high pressure port (3) both connected to the pressure of the aircraft engine.

The PRV (2) is in charge of isolation, i.e., EBAS OFF, and regulation of pressure of the compressed air delivered to the components of the aircraft. The upstream pressure flowing to the PRV (2) is the compressed air come from the intermediate pressure port (IP-3), which is the first port, and the high pressure port (HP-4), which is the second port on the casing of the compressor for the engine.

A regulation set point may be 42 psig if the two engine bleed systems (EBAS) are active and set at 50 psig of only one EBAS is active. If the pressure upstream of PRV (2) is smaller than the regulation set point, a pressure valve (HPV-11) is opened completely to minimize the pressure drop between the compressor and the PRV (2).

The position of the valve (2.1) of PRV (2) is controlled by the pressure difference between an opening chamber (5) and a closing chamber (6), shown in FIG. 2. Valve (2.1) may be a butterfly valve or other suitable type of valve. The closing chamber (6) is fluidically connected to the PRV (2) downstream of valve (2.1) via a sense line (7). The opening chamber (5) is fed from a regulator (8) in conjunction with a torque motor (9). Regulator (8) is fluidically connected to the PRV (2) upstream of valve (2.1) via sense line (8.1).

The torque motor (9) current is set using a PID controller (10) with feedback from a BPS (12). Thus, the regulation is preferably electro-pneumatic. The controller (10) takes into account transitions between EBAS OFF/ON and HPV (11) closed/open in order to deal with transients.

The method and system according to the present invention monitors the transient in the BPS regulation when the valve (2.1) in PRV (2) transitions from fully open to partially closed to regulate the bleed air in response to the opening of the high pressure valve (11).

The EBAS shown in FIG. 1 also comprises an intermediate pressure check valve (15) between the IP port (3) and the PRV (2), an overpressure valve (16) downstream of the PRV (2), a BMPS (17) for measuring the pressure upstream of the HPV (11), a differential pressure sensor (18), a bleed temperature sensor (19), a fan air valve (20), and a precooler (21).

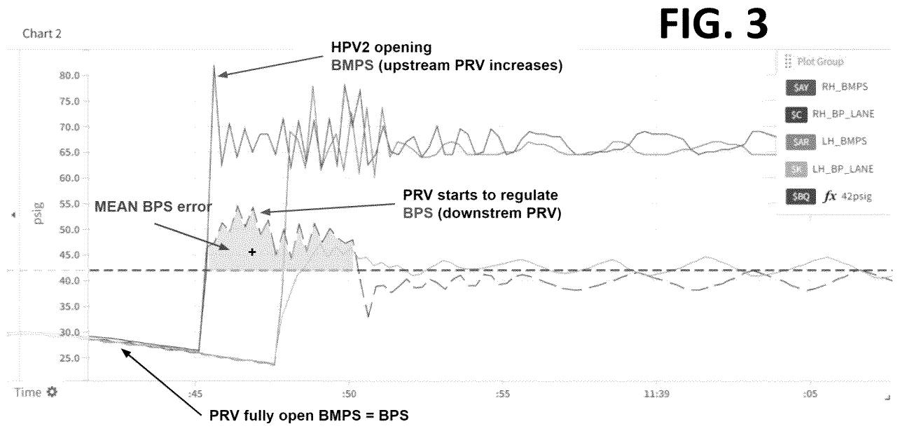

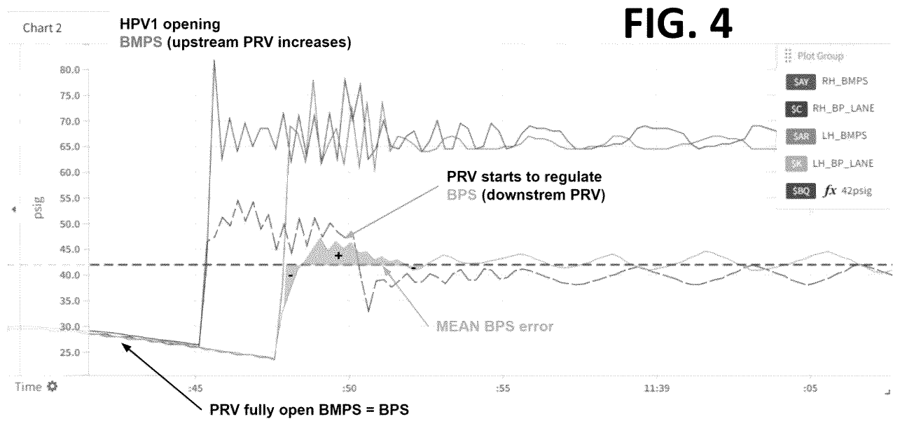

FIGS. 3 and 4 show the bleed pressure (BP_LANE/BPS) behavior during the HPV (11) opening for a healthy PRV (2), shown with a discontinuous line, and a PRV (2) close to failure, shown with a continuous line.

In particular, FIG. 3 shows the bleed pressure evolution in the transient response to the HPV (11) being opened during which the PRV (2) transitions from being fully open to partially closed to regulate the bleed air flowing with the high pressure air from the HP portion of the compressor. FIG. 3 shows the bleed pressure evolution during the transition for a healthy PRV (2), and FIG. 4 shows the bleed pressure evolution for a damaged PRV (2). The difference in the evolutions of bleed pressures shown in FIGS. 3 and 4 is used by the BMC to detect a damaged PRV (2) and to issue an alert of a need for predictive maintenance.

At the moment of the HPV (11) opens, the pressure sensed by BMPS (17) increases due to the adding of high pressure air from HP (4) to the conduit through which flows compressed air flowing from IP port (3). The pressure sensed by HPV (11) may increase to 65 psig due to the opening of HPV (11).

Before the HPV (11) opens, the PRV (2) is fully open. The PRV (2) starts regulating, e.g., partially closing, in response to the opening of the HPV (11). There is a short period during which both the PRV (2) and the HPV (11) are both fully open. During this period, the BMC may determine whether the PRV (2) is healthy, in that it is operating properly, or is in need of maintenance.

Although the setpoint in the case of two bleed operatives may be 42 psig, there will be an initial transient when the pressure reaching the PRVs (2) will be higher than in healthy PRVs, as shown in FIGS. 3 and 4. It is observed that the pressure during this transient will be lower for PRVs (2) that will exhibit a low pressure failure or damaged BPS (12) sense lines. The area will be greater than the healthy scenario for cases when the PRV (2) fails in an overpressure scenario.

To identify an event that may indicate need for predictive maintenance, the following aircraft parameters can be monitored during the flight:
Altitude [ALT]
Flight Phase [FP]
Pressure Regulating Valve (PRV) closure command (valve to be monitored) [LH_PRV_CMD and RH_PRV_CMD]
High Pressure Valve (HPV) closure command (located upstream the PRV) [LH_HPV_CMD and RH_HPV_CMD]
Pressure upstream the valve: Bleed Manifold Pressure Sensor (BMPS) [LH_BMPS and RH_BMPS], and
Pressure downstream the valve: Bleed Pressure Sensor (BPS) [LH_BMPS and RH_BMPS]

The predictive model makes uses, as an example, of the constant parameters in Table A that are adjusted to maximize its performance:

TABLE A

| Name | Description | Value |
|---|---|---|
| N seconds | Monitoring window during HPV | 5 |
| | opening (s) | |
| ALT min threshold | Minimum altitude for the | 15000 |
| | monitoring windows (ft) | |
| BMPS max threshold | Maximum BMPS before an | 40 |
| | opening (s) | |
| BMPS min threshold | Minimum BMPS for a | 50 |
| | monitoring window (psig) | |
| BPS ref | Reference value to calculate | 42 |
| | BPS error (psig) | |
| A | First coefficient for non- | 6.6 |
| | dimensionalization (psig) | |
| B | Second coefficient for non- | 0.059 |
| | dimensionalization (psig) | |
| Max pressure error | Maximum pressure error (%) | 100 |
| threshold | | |
| Mim pressure error | Minimum pressure error (%) | −100 |
| threshold | | |
| Cumulative event | Number of events for an alert | 7 |
| threshold | | |
| Flight window | Flight window | 10 |

For each flight, each side XX, wherein XX can be right, RH, or left, LH, identify the time windows matching the following conditions:

(FP = 6) AND (ALT > ALT_min_thr) AND
LH_PRV_CMD = 0 (open) AND RH_PRV_CMD = 0 (open) with
N_seconds conf time AND
XX_BMPS > BMPS_min_thr AND
XX_HPV_CMD = 0 (open) AND XX_HPV_CMD = 1 (closed)
N_seconds ago AND
XX_BMPS < BMPS_max_thr N_seconds ago

Rationales: Focus on switching during cruise phase; Ensure two bleed operative, regulation setpoint is different otherwise; Ensure that PRV is regulating (upstream pressure greater than regulation setpoint); HPV has just opened, and PRV was fully open before the HPV opening.

For each side, each time window, calculate:
Duration = T_end − T_start
Mean_Press_Error = Mean(XX_BPS − BPS_ref)
For each side, each flight:

Discard the feature if Duration <3 s. The remaining number of features after this filter is N_Features.

Max_Press_Error = Max(Mean_Press_Error)
Min_Press_Error = Min(Mean_Press_Error)

In order to make the metric non-dimensional, the following equations are applied:

```
  Max_Press_Error_percentage = (Max_Press_Error − A) / B
  Min_Press_Error_percentage = (Min_Press_Error − A) / B
  Press_Error_percentage = (Max_Press_Error_percentage +
Min_Press_Error_percentage) / 2
```

A and B are coefficients that convert the pressure error into a non-dimensional value (i.e. from engineering units in psig to a percentage). Its numerical values, as well as the values of: Max pressure error threshold, Mim pressure error threshold, Cumulative event threshold and Flight window have been calculated to maximize the detection rate (number of detections divided by number of real events) and confidence rate (number of useful alerts divided by the number of triggered alerts) based on a series of real events of in-service aircraft.

For each side, an event is identified if:

Press_Error_percentage < Min_pressure_error_threshold OR
Press_Error_percentage > Max_pressure_error_threshold

For each side, if the number of events in the last Window flights, XX_N_EVENTS, is bigger than Cumulative flights an alert shall be generated.

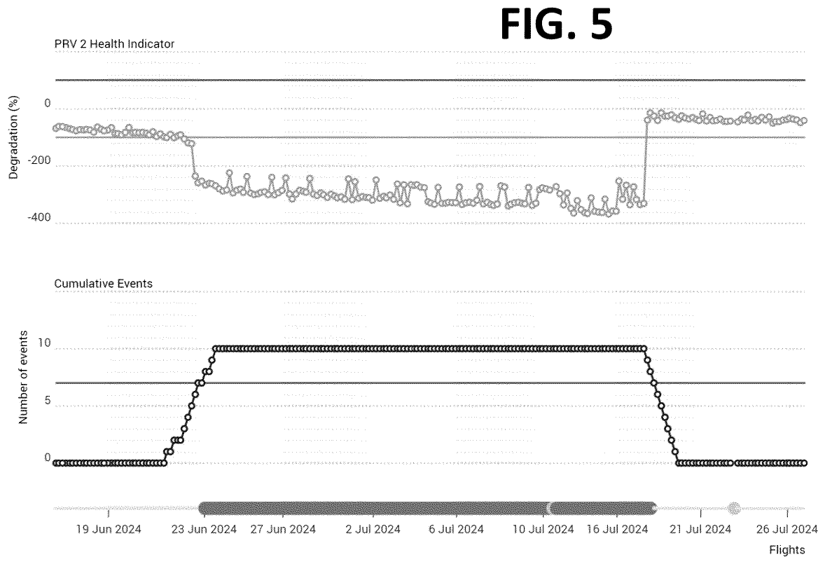

FIG. 5 shows an example of the feature Press_Error_percentage, named Degradation (%), and the number of events detected for a failure case, showing the recovery after the equipment removal.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft bleed air system comprising:
an engine comprising a first pressure port connected fluidically to an intermediate pressure portion of a compressor of the engine, and a second port connected fluidically to a high pressure portion of the compressor;
a first conduit having a first inlet connected to the first pressure port, a first outlet and a first intermediate connection between the first inlet and the first outlet;
a second conduit having a second inlet connected to the second pressure port and a second outlet connected to the first intermediate connection;
a high pressure valve in the second conduit and the high pressure valve is downstream of the second pressure port and upstream of the intermediate connection; and
a pressure regulating valve having an inlet connected to the first outlet and downstream of the first pressure port and the high pressure valve.

2. The aircraft bleed air system according to claim 1, wherein the pressure regulating valve is connected to a pressure regulator configured to regulate a pressure difference between an opening chamber and a closing chamber, wherein the opening chamber and the closing chamber are fluidically between the pressure regulating valve and the pressure regulator.

3. The aircraft bleed air system according to claim 2, wherein the pressure regulator valve is fluidically connected to the closing chamber by a sense line which is fluidically connected to the opening chamber.

4. The aircraft bleed air system according to claim 2, wherein the regulator is adjusted by a motor controlled by a controller.

5. The aircraft bleed air system according to claim 1, wherein a pressure check valve is in the first conduit between the first pressure port and the pressure regulating valve.

6. The aircraft bleed air system according to claim 1, further comprising a bleed manifold pressure sensor coupled to the first conduit upstream of the pressure regulating valve.

7. The aircraft bleed air system according to claim 2, further comprising a bleed pressure sensor coupled to a third conduit connected to and downstream of the pressure regulating valve.

8. A method for monitoring an aircraft bleed air system, wherein the aircraft bleed system includes a first pressure port fluidically connected to an intermediate or low pressure portion of a compressor in an aircraft engine, a second pressure port fluidically connected to a high pressure portion of the compressor; a first conduit having a first inlet connected to the first pressure port, an intermediate coupling and a first outlet; a second conduit having a second inlet coupled to the second pressure port and a second outlet coupled to the intermediate coupling of the first conduit, a high pressure valve in the second conduit, and a pressure regulating valve connected to the first outlet of the first conduit, wherein the method includes:
detecting a pressure transient in an evolution of pressure occurring in the first conduit upstream of the pressure regulating valve and downstream while the pressure regulating valve is fully open and the high pressure valve is opened;
determining that the pressure regulating valve functions correctly if the pressure transient is higher than a preset value;
determining that the pressure regulating valve is damaged if the pressure transient is lower than a preset value, and
issuing an alert of a defect in the aircraft bleed system or of a need of maintenance in the aircraft bleed system in response to the determination that the pressure regulating valve is damaged.

9. The method of claim 8, further comprising replacing or maintaining the pressure regulating valve in response to the alert.

10. The method according to claim 8, wherein the alert is emitted only if a plurality of determinations are made that the pressure regulating valve has a defect or needs maintenance during a predetermined period.

11. The method according to claim 8, wherein the determining that the pressure regulating valve is functioning correctly or damaged further comprising monitoring aircraft parameters while the aircraft is in flight and on opposite sides (LH, RH) of the aircraft, wherein the aircraft parameters include:
```
  altitude (ALT) of the aircraft;
  flight phase (FP) of the aircraft;
  a command to close the pressure regulating valve
(LH_PRV_CMD and RH_PRV_CMD);
  a command to close the high pressure valve
(LH_HPV_CMD and RH_HPV_CMD);
```
a pressure upstream of the high pressure valve being monitored by a bleed manifold pressure sensor (LH_BMPS and RH_BMPS); and
a pressure downstream the high pressure valve being monitored by a bleed pressure sensor (LH_BMPS and RH_BMPS).

12. The method according to claim 11, wherein for each flight of the aircraft and for each side XX of the aircraft, wherein XX is right side (RH) or left side (LH), wherein the method further comprises identifying a time periods based on the following conditions:
```
  (FP = 6) AND (ALT > ALT_min_threshold);
  LH_PRV_CMD = 0 (open) and RH_PRV_CMD = 0 (open)
with N_seconds;
  XX_BMPS > BMPS_min_threshold,
  XX_HPV_CMD = 0 (open) and XX_HPV_CMD = 1 (closed)
N_seconds ago; and
  XX_BMPS < BMPS_max_threshold N_seconds ago,
for each side of the aircraft for each of the time periods, calculate:
  Duration = T_end − T_start, and
  Mean_Press_Error = Mean(XX_BPS − BPS_ref) and
for each side of the aircraft for each flight:
  discard the feature if Duration < 3 s, the remaining number
of features after this filter being N_Features.
  Max_Press_Error = Max(Mean_Press_Error)
  Min_Press_Error = Min(Mean_Press_Error)
applying the following equations:
  Max_Press_Error_percentage = (Max_Press_Error − A) / B
  Min_Press_Error_percentage = (Min_Press_Error − A) / B
  Press_Error_percentage = (Max_Press_Error_percentage
+ Min_Press_Error_percentage) / 2
for each side, an event is identified if:
  Press_Error_percentage < Min_pressure_error_threshold;
or
  Press_Error_percentage > Max_pressure_error_threshold.
```

13. A method to monitor an aircraft bleed air system that includes:
a first conduit including an inlet fluidically coupled to a low or intermediate portion of a compressor of an aircraft and an outlet connected to a pressure regulating valve; a second conduit including an inlet fluidically connected to a high pressure portion of the compressor and an outlet connected to an intermediate connection in the first conduit upstream of the pressure regulating valve, and a high pressure valve in the second conduit,
wherein the method includes:
initially maintaining the pressure regulating valve in a fully open position while the high pressure valve is closed and preventing high pressure air from the high pressure portion from entering the first conduit;
opening the high pressure valve and thereafter adjusting the pressure regulating valve to regulate a flow of compressed air flowing from both the low or intermediate portion and the high pressure portion of the compressor to the pressure regulating valve;
during a period in which the high pressure valve is opened and the pressure regulating valve is fully opened, monitoring an evolution of pressures in the first conduit downstream of the intermediate connection and upstream of the pressure regulating valve;
analyzing the evolution of the pressures to determine a pressure transient during the period;
determining that the pressure regulating valve is operating properly if the pressure transient is higher than a preset value;
determining that the pressure regulating valve is damaged or in need of maintenance if the detected pressure transient is lower than the preset value, and
issuing an alert of a defect or of a need of maintenance in response to the determination that the pressure regulating valve is damaged or in need of maintenance.

14. The method of claim 13, further comprising replacing or maintaining the pressure regulating valve in response to the alert.

15. The method according to claim 13, wherein the alert is emitted only if a plurality of determinations that the pressure regulating valve is damaged during a predetermined period.
